(19) United States
(12) Patent Application Publication
(10) Pub. No.: US 2024/0176367 A1
(43) Pub. Date: May 30, 2024

(54) UAV DISPATCHING METHOD, SERVER, DOCK APPARATUS, SYSTEM, AND STORAGE MEDIUM

(71) Applicant: SZ DJI TECHNOLOGY CO., LTD., Shenzhen (CN)

(72) Inventors: Qi ZHOU, Shenzhen (CN); Xin KE, Shenzhen (CN); Wenkang ZHANG, Shenzhen (CN); Tian LUO, Shenzhen (CN)

(21) Appl. No.: 18/431,406

(22) Filed: Feb. 2, 2024

Related U.S. Application Data
(63) Continuation of application No. PCT/CN2021/111005, filed on Aug. 5, 2021.

(51) Int. Cl. G05D 1/654; B64U 70/90; G05D 109/20

(52) U.S. Cl. CPC G05D 1/654; B64U 70/90; B64U 2201/20; G05D 2109/20

(57) ABSTRACT

A server includes at least one processor and at least one memory. The at least one memory includes computer program code. The at least one memory and the computer program code are configured, with the at least one processor, to cause the server to at least obtain task description information of a target task and status information of one or more dock apparatuses communicatively connected to the server, determine a target dock apparatus from the one or more dock apparatuses according to the task description information and the status information, and send a dispatching instruction to the target dock apparatus to instruct the target dock apparatus to select, according to the dispatching instruction, a target UAV from one or more UAVs to perform the target task. The one or more UAVs are carried by and communicatively connected to the target dock apparatus.

### CROSS-REFERENCE TO RELATED APPLICATION

The present disclosure is a continuation of International Application No. PCT/CN2021/111005, filed Aug. 5, 2021, the entire content of which is incorporated herein by reference.

### TECHNICAL FIELD

The present disclosure relates to the unmanned aerial vehicle (UAV) field and, more particularly, to a UAV dispatching method, a server, a dock apparatus, a system, and a storage medium.

### BACKGROUND

With the development of unmanned aerial vehicles (UAVs), UAVs are broadly applied to various fields, including aerial surveying, power line inspection, natural gas (oil) pipeline inspection, forest fire prevention, and disaster rescue. Currently, when a UAV needs to perform tasks, a user needs to transport the UAV to the task area or a place near the task area. Then, the user manually controls the UAV to perform the tasks by a remote controller, or the UAV follows a pre-determined flight path to perform the tasks. However, some places are hard for the user to reach, which causes the UAV to be unable to perform the tasks. Therefore, the application range of the UAV is limited, and the user experience is poor.

### SUMMARY

In accordance with the disclosure, there is provided a server, including at least one processor and at least one memory. The at least one memory includes computer program code. The at least one memory and the computer program code are configured, with the at least one processor, to cause the server to at least obtain task description information of a target task and status information of one or more dock apparatuses communicatively connected to the server, determine a target dock apparatus from the one or more dock apparatuses according to the task description information and the status information, and send a dispatching instruction to the target dock apparatus to instruct the target dock apparatus to select, according to the dispatching instruction, a target UAV from one or more UAVs to perform the target task. The one or more UAVs are carried by and communicatively connected to the target dock apparatus.

Also in accordance with the disclosure, there is provided a server, including at least one processor and at least one memory. The at least one memory includes computer program code. The at least one memory and the computer program code are configured, with the at least one processor, to cause the server to at least obtain task description information of a target task, obtain status information of one or more UAVs carried by a target dock apparatus and communicatively connected to the target dock apparatus, and send a dispatching instruction to the target dock apparatus to instruct the target dock apparatus to select, from the one or more UAVs, a target UAV to perform the target task, and control the target UAV to perform the target task. The dispatching instruction is generated based on the task description information and the status information.

### BRIEF DESCRIPTION OF THE DRAWINGS

FIG. 1 is a schematic diagram showing a scene for an unmanned aerial vehicle (UAV) dispatching method consistent with an embodiment of the present disclosure.

FIG. 2 is a schematic flowchart of a UAV dispatching method consistent with an embodiment of the present disclosure.

FIG. 3 is a schematic diagram showing a distribution of dock apparatuses consistent with an embodiment of the present disclosure.

FIG. 4 is a schematic diagram of a target flight path between a to-be-maintained UAV and a maintenance point consistent with an embodiment of the present disclosure.

FIG. 5 is a schematic flowchart of another UAV dispatching method consistent with an embodiment of the present disclosure.

FIG. 6 is a schematic structural block diagram of a server consistent with an embodiment of the present disclosure.

FIG. 7 is a schematic structural block diagram of a dock apparatus consistent with an embodiment of the present disclosure.

FIG. 8 is a schematic structural block diagram of a UAV dispatching system consistent with an embodiment of the present disclosure.

### DETAILED DESCRIPTION OF THE EMBODIMENTS

The technical solution of embodiments of the present disclosure is described in detail in connection with the accompanying drawings. Described embodiments are some embodiments of the present disclosure, not all embodiments. Based on embodiments of the present disclosure, all other embodiments obtained by those of ordinary skill in the art without creative efforts are within the scope of the present disclosure.

The flowchart shown in the accompanying drawings is for illustrative purposes only, does not necessarily include all the content and operations/processes, and is not necessarily performed according to the described sequence. For example, some operations/processes can be further divided, grouped, or partially combined. Therefore, the actual execution sequence can be different according to specific situations.

Embodiments of the present disclosure are described in detail below in connection with the accompanying drawings. When there is no conflict, embodiments and features of embodiments can be grouped with each other.

With the development of unmanned aerial vehicles (UAVs), UAVs are broadly applied to various fields, including aerial surveying, power line inspection, natural gas (oil) pipeline inspection, forest fire prevention, and disaster rescue. Currently, when a UAV is needed to perform tasks, a user needs to transport the UAV to the task area or a place near the task area. Then, the user manually controls the UAV to perform the tasks by a remote controller, or the UAV follows a pre-determined flight path to perform the tasks. However, some places are hard for the user to reach, which causes the UAV to be unable to perform the tasks. Therefore, the application range of the UAV is limited, and the user experience is poor.

To address the above issues, embodiments of the present disclosure provide an unmanned aerial vehicle (UAV) dispatching method, a server, a dock apparatus, a system, and a storage medium. Task description information of a to-be-performed target task and status information of at least one dock apparatus can be obtained. according to the task description information and the status information, a target dock apparatus can be determined from the at least one dock apparatus. Then, a UAV dispatching instruction can be sent to the target dock apparatus to instruct the target dock apparatus to select a target UAV from the at least one UAV to perform the target task according to the task description information of the UAV dispatching instruction. Thus, the user does not need to transport the UAV to the task area or the place near the task area, and the UAV can still be used to perform the task, which greatly improves the convenience and application range of the UAV. The user experience can be also improved.

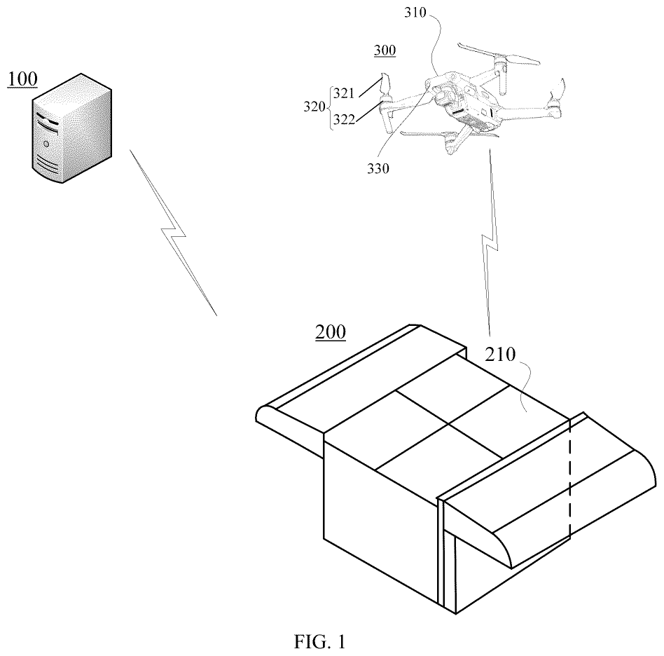

FIG. 1 is a schematic diagram showing a scene for a UAV dispatching method consistent with an embodiment of the present disclosure. As shown in FIG. 1, a server 100, at least one dock apparatus 200, and at least one UAV 300 are included. The server 100 communicates with the dock apparatus 200 and the UAV 300. The dock apparatus 200 communicates with the UAV 300.

In some embodiments, the server 100 can include a first communication device, the dock apparatus 200 can include a second communication device, and the UAV 300 can include a third communication device. The first communication device and the second communication device can realize the communicative connection between the server 100 and the dock apparatus 200. The first communication device and the third communication device can realize the communicative connection between the server 100 and the UAV 300. The second communication device and the third communication device can realize the communicative connection between the dock apparatus 200 and the UAV 300. The third communication device may include but is not limited to a 4G communication device, a 5G communication device, and a 6G communication device.

In some embodiments, the UAV 300 includes a body 310, a power system 320 arranged at the body 310, a payload 330, and a control system (not shown in FIG. 1). The power system 320 can be configured to provide flight power to the UAV 300. The payload 330 can include, but is not limited to, a camera device, a radar device, a spectral camera, a spraying device, and a lighting device. The UAV 300 can include a rotary-wing UAV, such as a single-rotor UAV, a dual-rotor UAV, a quad-rotor UAV, a hexa-rotor UAV, an octo-rotor UAV, a fixed-wing UAV, or a UAV of a combination of rotary-wings and fixed-wings.

The power system 320 can include one or more propellers 321, one or more motors 322 corresponding to one or more propellers, and one or more electronic speed controllers (ESCs). A motor 322 is connected between an ESC and a propeller 321. The motor 322 and the propeller 321 are arranged at the body 310. The ESC can be configured to receive a control signal generated by the control system and provide a drive current to the motor 322 according to the drive signal to control the rotation speed of the motor 322. The motor 322 can be configured to drive the propeller 321 to rotate to provide power to the flight of the UAV 300. The power can enable the UAV 300 to realize motion of one or more degrees of freedom. In some embodiments, the UAV 300 can rotate around one or more rotation axes. For example, the rotational axes can include a roll axis, a yaw axis, and a pitch axis. The motor 322 can include a DC motor or an AC motor. Furthermore, the motor 322 can include a brushless motor or a brushed motor.

The control system can include a processor and a sensor system. The sensor system can be configured to measure attitude information of the UAV 300, including position information and status information of the UAV 300 in space, for example, a three-dimensional position, a three-dimensional angle, a three-dimensional velocity, a three-dimensional acceleration, and a three-dimensional angular velocity. The sensor system can include at least one of a gyroscope, an ultrasonic sensor, an electronic compass, an inertial measurement unit (IMU), a vision sensor, a global navigation satellite system, or a barometer. The processor can be configured to control the movement of the UAV 300. For example, the processor can be configured to control the movement of the UAV 300 according to the attitude information measured by the sensor system. The processor can be configured to control the UAV 300 according to a pre-coded program instruction.

In some embodiments, the server 100 can be configured to obtain task description information of a to-be-performed target task and status information of at least one dock apparatus 200. According to the task description information and status information, the server can be configured to determine the target dock apparatus from the at least one dock apparatus 200 and send the UAV dispatching instruction to the target dock apparatus to instruct the target dock apparatus to select the target UAV from the at least one UAV to perform the target task based on the task description information within the UAV dispatching instruction.

In some embodiments, as shown in FIG. 1, the dock apparatus 200 includes at least one dock 210 and a positioning device (not shown in FIG. 1). In some embodiments, the dock apparatus shown in FIG. 1 includes four docks. The positioning device can be configured to collect the position of the dock apparatus 200. Each dock 210 includes a charging device. The charging device can be configured to charge the UAV parked at the dock 210. The charging device can include a wireless charging device.

In some embodiments, when the dock apparatus 200 detects that a UAV 300 is parked on a dock, the dock apparatus 200 can obtain the remaining battery level of the UAV 300. If the remaining battery level of the UAV 300 is below a predetermined battery level threshold, the charging device of the dock where the UAV 300 is can be activated to allow the charging device to charge the battery of the UAV 300. The dock apparatus 200 can also include a detection device and a weather system. The detection device can be configured to collect three-dimensional environmental information of the area where the dock apparatus is located. The weather system can be configured to observe meteorological information about the environment surrounding the dock apparatus 200. The detection device can include a radar device, a binocular vision device, and a 3D time-of-flight (TOF) sensor. The weather system can include an anemometer, a temperature and humidity sensor, a camera, a lightning rod, and a rain sensor.

The UAV dispatching method of embodiments of the present disclosure is described in detail below in connection with the scene shown in FIG. 1. The scene of FIG. 1 is only used to describe the UAV dispatching method of embodiments of the present disclosure and does not limit the application scene of the UAV dispatching method of embodiments of the present disclosure.

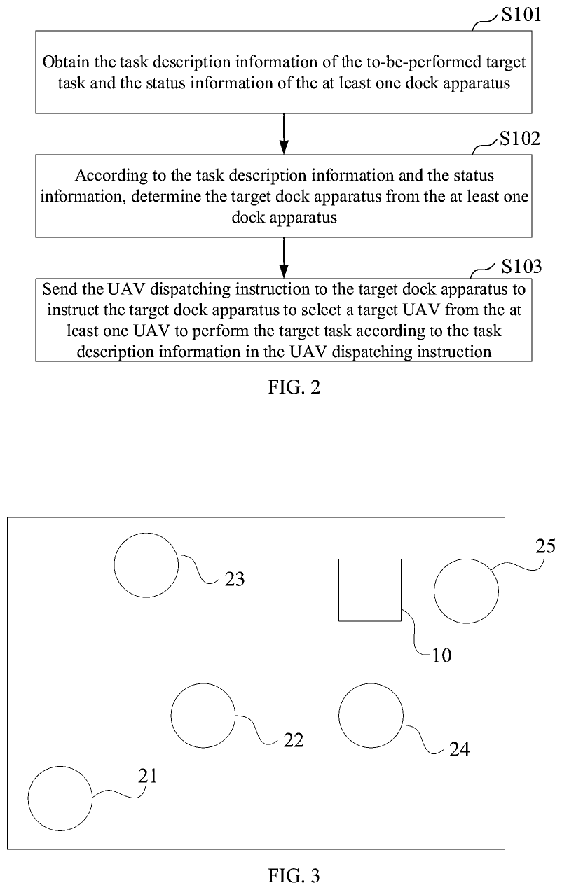

FIG. 2 is a schematic flowchart of a UAV dispatching method consistent with an embodiment of the present disclosure. This UAV dispatching method can be applied to a server and configured to dispatch the UAV to perform tasks.

As shown in FIG. 2, the UAV dispatching method includes processes S101 to S103.

At S101, the task description information of the to-be-performed target task and the status information of the at least one dock apparatus are obtained.

The task description information can include at least one of a first position of a task execution area for the target task or a first payload type required for performing the target task. The status information of the dock apparatus can include at least one of a second position of the dock apparatus, a second payload type of the payload carried by the at least one UAV parked on the dock apparatus, or the meteorological information of the area where the dock apparatus is located.

In some embodiments, a terminal apparatus can display a task creation page. The task creation page can include a task creation icon. In response to a triggering operation of the user on the task creation icon, an area selection page can be displayed. The area selection page can include a predetermined map, a payload type selection icon, a confirmation icon, and a task execution icon. The task execution area selected by the user on the area selection page and the first position of the task execution area can be obtained. The task execution area can be marked on the predetermined map. In response to the triggering operation of the user on the payload type selection icon, a payload type list can be displayed. The payload type selected by the user from the payload type list can be obtained. In response to the triggering operation of the user on the confirmation icon, a corresponding task can be created, and corresponding task description information can be generated according to the first position and the selected payload type. In response to the triggering operation of the user on the task execution icon, the task currently created can be used as the to-be-performed target task. The task description information of the target task can be sent to the server.

In some embodiments, the terminal apparatus can respond to the triggering operation of the user on the task selection icon on the task creation page to display the task selection page that includes task identification information, obtain the task identification information selected by the user on the task selection page, use the task corresponding to the task identification information as the target task, and send the task description information of the target task to the server.

In some embodiments, the dock apparatus can obtain status information of at least one UAV that is communicatively connected to the dock apparatus, obtain the second position of the dock apparatus, generate the status information of the dock apparatus according to the status information of the UAV and the second position of the dock apparatus, and send the status information of the dock apparatus to the server. The status information of the UAV can include at least one of the second payload type of the payload carried by the UAV, the status identification information of the UAV, and the remaining battery level of the UAV. The status identification information can be used to identify whether the UAV is in an idle status or an operation status.

In some embodiments, the server can store the status information of each dock apparatus. When the status information of the dock apparatus is changed, the server can update the stored status information of the dock apparatus synchronously. Thus, the status information of the dock apparatus in the server can be the latest, which facilitates accurately determining the target dock apparatus subsequently.

At S102, according to the task description information and the status information, the target dock apparatus is determined from the at least one dock apparatus.

The target dock apparatus can be closest to the task execution area of the target task. The second type payload provided by the target dock apparatus can match the first payload type required for performing the target task, and/or the meteorological information of the area where the target dock is located can satisfy the predetermined meteorological condition. The first payload type or the second payload type can include a payload type corresponding to the camera device, a payload type corresponding to the lighting device, a payload type corresponding to the radar device, a payload type corresponding to the spectral camera, and a payload type corresponding to the spraying device, which can be same as or different from the payload carried by the at least one UAV that is communicatively connected to the dock apparatus.

In some embodiments, determining the target dock apparatus from the at least one dock apparatus according to the task description information and the status information can include determining a first distance between the task execution area and each dock apparatus according to the first position of the task execution area of the target task and the second position of each dock apparatus, and determine the target dock apparatus from the at least one dock apparatus according to the first distance. In some embodiments, the dock apparatus corresponding to the shortest first distance can be determined as the target dock apparatus. By selecting the dock apparatus closest to the task execution area, the dock apparatus can quickly dispatch the UAV to perform the target task.

In some embodiments, as shown in FIG. 3, distances between the task execution area 10 and the dock apparatus 21, the dock apparatus 22, the dock apparatus 23, the dock apparatus 24, and the dock apparatus 25 are 150 m, 60 m, 75 m, 45 m, and 30 m, respectively. The dock apparatus 25 closest to the task execution area 10 can be determined as the target dock apparatus.

The first position of the task execution area can include a first predetermined position in the task execution area. The second position can include a second predetermined position of the dock apparatus. The first predetermined position can be the center position of the task execution area or the starting point position of the target task. The second predetermined position can be the center position of the dock apparatus or a boundary position of the dock apparatus, which is not limited in embodiments of the present disclosure.

The distance between the task execution area and the dock apparatus can include the distance between the first predetermined position and the second predetermined position, for example, the distance between the center position of the task execution area and the center position of the dock apparatus, or the distance between the starting point position of the target task in the task execution area and the center position of the dock apparatus.

In some embodiments, determining the target dock apparatus from the at least one dock apparatus according to the task description information and the status information can include determining a first length corresponding to the flight path between the task execution area and each dock apparatus according to the first position of the task execution area of the target task and the second position of each dock apparatus, and determining the target dock apparatus from the at least one dock apparatus according to the first length corresponding to each flight path. In some embodiments, the dock apparatus corresponding to the shortest first length can be determined as the target dock apparatus. By selecting the dock apparatus corresponding to the shortest flight path, the dock apparatus can quickly dispatch the UAV to perform the target task.

In some embodiments, the first payload type can be matched with the second payload type to obtain a payload matching result. According to the payload matching result, the target dock apparatus can be determined from at least one dock apparatus. For example, the dock apparatus corresponding to the payload matching result of the second payload type matching the first payload type can be determined as the target dock apparatus. The payload matching result can include the second payload type matching or not matching the first payload type. The target dock apparatus can be determined by considering the payload type provided by the dock apparatus and the payload required by the target task. Thus, the determined target dock apparatus can satisfy the payload needs of the target task to facilitate the target task to be performed.

In some embodiments, the dock apparatuses corresponding to the payload matching result of the second payload type matching the first payload type can be determined as candidate dock apparatuses. The target dock apparatus can be determined from the candidate dock apparatuses. For example, according to the first position of the task execution area of the target task and the second positions of the candidate dock apparatuses, the second distances between the task execution area and the candidate dock apparatuses can be determined. According to the second distances, the target dock apparatus can be determined from the at least one candidate dock apparatus. The candidate dock apparatus corresponding to the shortest second distance can be determined as the target dock apparatus.

As shown in FIG. 3, the UAV communicatively connected to the dock apparatus 21 carries a camera device, the UAV communicatively connected to the dock apparatus 22 carries a radar device, the UAV communicatively connected to the dock apparatus 23 carries both a camera and a radar device, the UAV communicatively connected to the dock apparatus 24 carries a spraying device, and the UAV communicatively connected to the dock apparatus 25 carries a lighting device. The required payload for the target task is a radar device. Therefore, the dock apparatus 22 and the dock apparatus 23 can be determined as candidate dock apparatuses. Since the dock apparatus 22 is closest to the task execution area, the dock apparatus 22 can be determined as the target dock apparatus.

For example, according to the first position of the task execution area for the target task and the second position of the candidate dock apparatuses, a second length corresponding to the flight path between the task execution area and each candidate dock apparatus can be determined. According to the second length, the target dock apparatus can be then determined from the at least one candidate dock apparatus. The candidate dock apparatus corresponding to the shortest second length can be determined as the target dock apparatus.

For example, the candidate dock apparatuses can be screened according to the meteorological information of the areas where the dock apparatuses are located. The meteorological information of the screened candidate dock apparatuses can satisfy the predetermined meteorological condition. The target dock apparatus can be determined from the screened candidate dock apparatuses. The target dock apparatus can be determined by considering the meteorological information of the areas where the dock apparatuses are located, the payload type provided by the dock apparatuses, and the payload needs of the target task. Thus, the determined target dock apparatus can satisfy the meteorological needs of the target task and the payload needs, which facilitates the target task to be performed.

The predetermined meteorological condition can be set based on actual conditions, which is not limited by embodiments of the present disclosure. For example, the predetermined meteorological condition can include a wind speed less than or equal to 8 m/s and sunny or cloudy weather. For example, all UAVs in the dock apparatus 24 can carry a radar device. Some of the UAVs in the dock apparatus 25 can carry a camera device, and other UAVs can carry a radar device. The payload required by the target task can be a radar device. The weather at the dock apparatus 24 can be sunny with a wind speed of 8.5 m/s. The weather at the dock apparatus 25 can be cloudy with a wind speed of 7 m/s. Thus, the dock apparatus 25 can be determined as the target dock apparatus.

At S103, the UAV dispatching instruction is sent to the target dock apparatus to instruct the target dock apparatus to select a target UAV from the at least one UAV to perform the target task according to the task description information in the UAV dispatching instruction.

After determining the target dock apparatus, the server can send the UAV dispatching instruction to the target dock apparatus. After receiving the UAV dispatching instruction, the target dock apparatus can select the target UAV from the at least one UAV communicatively connected to the target dock apparatus based on the task description information in the UAV dispatching instruction and control the target UAV to fly to the task execution area. Then, after the target UAV arrives at the task execution area, the target UAV can be controlled to perform the target task. The target task can include an aerial photography task, a surveying task, a spraying task, or a point cloud data collection task.

In some embodiments, the target dock apparatus can plan the first flight path between the target UAV and the task execution area and the second flight path for executing the target task within the task execution area. The target dock apparatus can send the first flight path and the second flight path to the target UAV to cause the UAV to fly from the target dock apparatus to the task execution area according to the first flight path, and after the target UAV arrives at the task execution area, the target UAV can perform the target task in the task execution area according to the second flight path.

In some embodiments, a prepare-to-land request from the UAV can be obtained. According to the prepare-to-land request, a prepare-to-land dock apparatus configured to prepare the landing for the prepare-to-land UAV can be determined from the at least one dock apparatus. The prepare-to-land UAV can be controlled to fly to the prepare-to-land dock apparatus. The prepare-to-land request can include the current position of the prepare-to-land UAV. The prepare-to-land UAV can include the target UAV or other UAVs, which is not limited in the present disclosure.

For example, the second position of the at least one dock apparatus can be obtained. The prepare-to-land dock apparatus can be determined from the at least one dock apparatus according to the second position of the at least one dock apparatus and the current position of the prepare-to-land UAV. For example, according to the current position of the prepare-to-land UAV and the second position of the at least one dock apparatus, the third distance between the prepare-to-land UAV and each dock apparatus can be determined. According to the third distance, the prepare-to-land dock apparatus can be determined from the at least one dock apparatus. The dock apparatus corresponding to the shortest third distance can be determined as the prepare-to-land dock apparatus. The prepare-to-land dock apparatus can be determined from the at least one dock apparatus based on the current position of the UAV and the position of each dock apparatus when the UAV needs to prepare for landing. Thus, the UAV can quickly prepare for landing, and the safety of the landing preparation of the UAV can be ensured.

In some embodiments, while the target UAV performs the target task, the target UAV can obtain the remaining battery level. If the remaining battery level is below or equal to a predetermined battery level threshold, a prepare-to-land request can be sent to the target dock apparatus. The target dock apparatus can determine whether the target dock apparatus satisfies the predetermined prepare-to-land conditions based on the prepare-to-land request. If the target dock apparatus satisfies the predetermined prepare-to-land conditions, a prepare-to-land confirmation information can be sent to the UAV. When the target UAV receives the prepare-to-land confirmation information, the target UAV can fly to the target dock apparatus. After arriving at the target dock apparatus, the target UAV can land in the target dock apparatus. When the target UAV needs to prepare for landing, if the takeoff dock apparatus of the target UAV (the target dock apparatus) satisfies the prepare-to-land conditions, the target UAV can directly prepare for landing at the takeoff dock apparatus, which facilitates the target UAV to quickly prepare for landing and ensures the safety of the landing preparation of the target UAV.

In some embodiments, if the target dock apparatus does not meet the predetermined prepare-to-land conditions, the target dock apparatus can send a prepare-to-land cancellation message to the target UAV. After the target UAV receives the prepare-to-land cancellation message, the target UAV can send a prepare-to-land request to the server. The server can determine a prepare-to-land dock apparatus configured to prepare for the landing of the target UAV from the at least one dock apparatus according to the prepare-to-land request. The server can control the target UAV to fly to the prepare-to-land dock apparatus. That is, the server can send a prepare-to-land instruction to the target UAV to instruct the target UAV to fly to the prepare-to-land dock apparatus to prepare for landing according to the position information of the prepare-to-land dock apparatus in the prepare-to-land instruction. When the takeoff dock apparatus of the target UAV does not satisfy the prepare-to-land conditions, the server can determine the prepare-to-land dock apparatus, which facilitates the target UAV to quickly prepare for landing and ensures the safety of the landing preparation of the target UAV.

In some embodiments, the server can plan a prepare-to-land flight path for the target UAV according to the position of the prepare-to-land dock apparatus and the current position of the target UAV. The server can then control the target UAV to follow the planned prepare-to-land flight path to the prepare-to-land dock apparatus. That is, the server can send the prepare-to-land flight path to the target UAV, and the UAV can follow the prepare-to-land flight path to fly to the prepare-to-land dock apparatus. When the target UAV arrives above the prepare-to-land dock apparatus, the target UAV can land on an empty dock of the prepare-to-land dock apparatus.

In some embodiments, the third position of a task-ending waypoint of the target UAV can be obtained. The task-ending waypoint can be a waypoint when the target UAV completes the target task. According to the third position and the position of the target dock apparatus, a fourth distance between the target dock apparatus and the task-ending waypoint can be determined. When the fourth distance is smaller than or equal to the predetermined distance, the target UAV can be controlled to fly to the target dock apparatus after completing the target task. The predetermined distance can be set according to the actual situation, which is not limited in the present disclosure.

In some embodiments, when the fourth distance is greater than the predetermined distance, a return dock apparatus for the return of the target UAV can be determined from the at least one dock apparatus. The target UAV can be controlled to fly to the return dock apparatus after completing the task. When the task-ending waypoint is far away from the target dock apparatus, the return dock apparatus can be determined from the other dock apparatuses. Thus, after the target UAV completes the target task, the target UAV can return to the return dock apparatus, which shortens flight time for returning and facilitates the target UAV to return.

In some embodiments, the dock apparatus of the at least one dock apparatus closest to the target UAV can be determined as the return dock apparatus. For example, the target dock apparatus can be dock apparatus B. Distances between the task-ending waypoint and dock apparatus A, dock apparatus C, and dock apparatus D can be 800 m, 200 m, and 500 m, respectively. Since the task-ending waypoint has the shortest distance to dock apparatus C, dock apparatus C can be determined as the return dock apparatus for the target UAV.

In some embodiments, a UAV maintenance request can be obtained. The UAV maintenance request can include the current position of the to-be-maintained the UAV and a fourth position of the maintenance point. The battery information of the UAV can be obtained, and a remaining flight distance of the to-be-maintained UAV can be determined according to the battery information. According to the current position, the fourth position, and the remaining flight distance of the to-be-maintained UAV, the target flight path for the to-be-maintained UAV to fly to the maintenance point can be determined. The to-be-maintained UAV can be controlled to fly to the maintenance point along the target flight path. The to-be-maintained UAV can be dispatched to the maintenance point through the UAV maintenance request. Then, the user can take the to-be-maintained UAV back for maintenance.

In some embodiments, the terminal apparatus can display a UAV maintenance page and obtain the to-be-maintained UAV and the maintenance point selected by the user on the UAV maintenance page, obtain the current position of the to-be-maintained UAV and the fourth position of the maintenance point selected by the user, and send the UAV maintenance request to the server according to the current position of the to-be-maintained UAV and the fourth position of the maintenance point. The server can obtain the UAV maintenance request sent by the terminal apparatus. When the UAV needs maintenance, the user can select the to-be-maintained UAV and the maintenance point through the human-computer interaction page. Thus, the server can dispatch the UAV based on the maintenance point to fly to the maintenance point. Thus, the user can take the to-be-maintained UAV back.

In some embodiments, according to the current position of the to-be-maintained UAV, the fourth position of the maintenance point, and the remaining flight distance, determining the target flight path for the to-be-maintained UAV to fly to the maintenance point can include according to the current position of the to-be-maintained UAV and the fourth position, determining the first flight path between the to-be-maintained UAV and the maintenance point, and when the length corresponding to the first flight path is smaller than or equal to the remaining flight distance, determining the first flight path as the target flight path. When the length corresponding to the flight path between the to-be-maintained UAV and the maintenance point is smaller or equal to the remaining flight distance, the to-be-maintained UAV can arrive at the maintenance point without charging.

In some embodiments, when the length corresponding to the first flight path is greater than the remaining flight distance, the remaining flight dock apparatus can be determined from the at least one dock apparatus according to the current position of the to-be-maintained UAV, the fourth position, and the remaining flight distance. The second flight path formed by the current position of the to-be-maintained UAV, the position of the at least one remaining flight dock apparatus, and the fourth position can be determined. The second flight path can be determined as the target flight path. Thus, the to-be-maintained UAV can fly to the maintenance point from the current position of the to-be-maintained UAV through the at least one remaining flight dock apparatus. The flight distance between the two neighboring waypoints in the second flight path can be smaller than or equal to the remaining flight distance. By planning the target flight path including the power supply dock apparatus, the to-be-maintained UAV can be charged by the power supply dock apparatus to cause the to-be-maintained UAV to arrive at the maintenance point smoothly when the to-be-maintained UAV flies according to the target flight path.

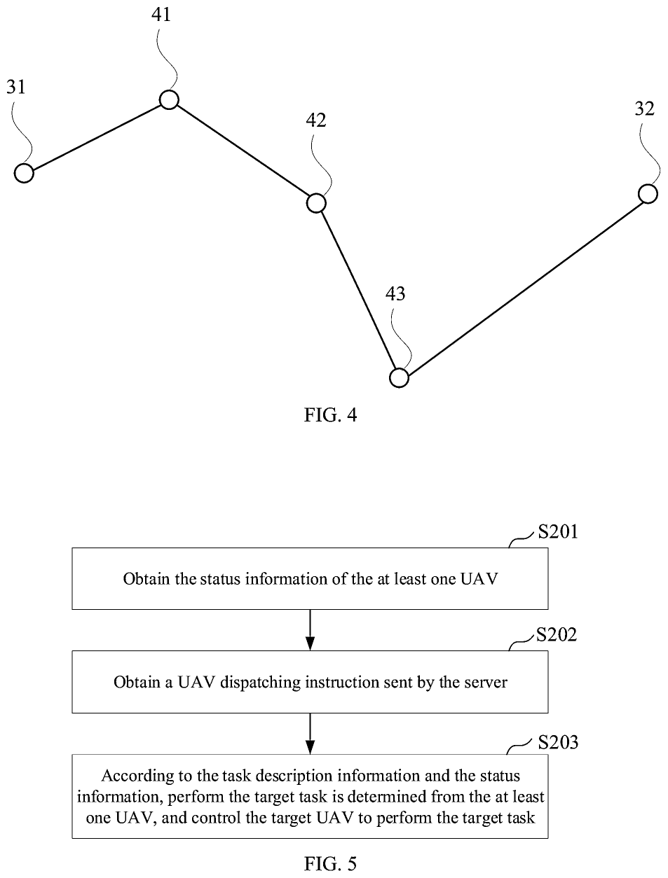

For example, as shown in FIG. 4, if the current position of the to-be-maintained UAV is waypoint 31, the waypoint corresponding to remaining flight dock apparatus A is waypoint 42, the waypoint corresponding to remaining flight dock apparatus B is waypoint 43, the waypoint corresponding to remaining flight dock apparatus C is waypoint 41, and the waypoint corresponding to the fourth position of the maintenance point is waypoint 32. Since distances between the current position of the to-be-maintained UAV and remaining flight dock apparatus C, remaining flight dock apparatus A, and remaining flight dock apparatus B are d1, d2, and d3, respectively, and d1<d2<d3, the target flight path can be obtained by connecting the flight path 41, the flight path 42, the flight path 43, and the flight path 32 in sequence starting from the waypoint 31.

For example, according to the current position of the to-be-maintained UAV and the position of each dock apparatus, the fifth distance between the to-be-maintained UAV and the dock apparatus can be determined. The dock apparatus corresponding to the shortest fifth distance can be determined as the first remaining flight dock apparatus. The distance between the first remaining flight dock apparatus and the to-be-maintained UAV can be smaller than or equal to the remaining flight distance. If the distance between the first remaining flight dock apparatus and the maintenance point is smaller than or equal to the remaining flight distance, the determination of the remaining flight dock apparatus can be stopped.

For example, if the distance between the first remaining flight dock apparatus and the maintenance point is greater than the remaining flight distance, the sixth distance between the first remaining flight dock apparatus and the dock apparatus can be determined. The dock apparatus corresponding to the shortest sixth distance can be determined as the second remaining flight dock apparatus. The distance between the second remaining flight dock apparatus and the to-be-maintained UAV can be smaller than or equal to the remaining flight distance. If the distance between the second remaining flight dock apparatus and the maintenance point is smaller than or equal to the remaining flight distance, the determination of the remaining flight dock apparatus can be stopped.

In the UAV dispatching method of embodiments of the present disclosure, the task description information of the to-be-performed target task and the status information of the at least one dock apparatus can be obtained. Then, the target dock apparatus can be determined from the at least one dock apparatus according to the task description information and the status information. Then, the UAV dispatching instruction can be sent to the target dock apparatus to instruct the target dock apparatus to select the target UAV from the at least one UAV to perform the target task according to the task description information in the UAV dispatching instruction. Thus, the user does not need to transfer the UAV to the task execution area or the position near the task execution area and can still use the UAV to perform the task, which greatly improves the convenience and application scope of the UAV and improves the user experience.

FIG. 5 is a schematic flowchart of another UAV dispatching method consistent with an embodiment of the present disclosure. The UAV dispatching method can be applied to the dock apparatus for dispatching the UAV to perform tasks. The dock apparatus can be configured to carry at least one UAV and be communicatively connected to the at least one UAV. The dock apparatus can be connected to the server. The dock apparatus can be deployed at a top of a building, in a cave, at a mobile carrier, etc., which is not limited here.

As shown in FIG. 5, the UAV dispatching method includes processes S201 to S203.

At S201, the status information of the at least one UAV is obtained.

The status information of the UAV can include at least one of a second payload type of a payload carried by the UAV, status identification information of the UAV, and the remaining battery power of the UAV. This status identification information can be used to indicate whether the UAV is in an idle state or an operation state.

At S202, a UAV dispatching instruction sent by the server is obtained.

The UAV dispatching instruction can include the task description information of the target task. The target task can include but is not limited to a survey task, an aerial photography task, a spraying task, a lighting task, and a point cloud data collection task. The task description information can include at least one of a first load type required for executing the target task or meteorological information in the area where the dock apparatus is located. The first payload type can include a payload type corresponding to the camera device, a payload corresponding to the lighting device, a payload type corresponding to the radar device, a payload type corresponding to the spectral camera, and a payload type corresponding to the spraying device.

At S203, according to the task description information and the status information, the target UAV configured to perform the target task is determined from the at least one UAV, and the target UAV is controlled to perform the target task.

In some embodiments, the first payload type can be matched with the second payload type to obtain the payload-matching result. According to the payload matching result, the target UAV can be determined from the at least one UAV. The UAV corresponding to the payload matching result of the first payload type matching the second payload type can be determined as the target UAV. For example, the dock apparatus can include UAV A, UAV B, UAV C, and UAV D. UAV A can carry the radar device, and UAVs B, C, and D can all carry spectral cameras. The payload required for the target task can be the radar device. UAV A can be selected as the target UAV since UAV A carries the radar device.

In some embodiments, the UAV corresponding to the payload matching result of the first payload type matching the second payload type can be determined as the candidate UAV. The candidate UAV with the most remaining battery power can be selected from the at least one UAV as the target UAV. For example, the dock apparatus can include UAV A, UAV B, UAV C, and UAV D. UAV A and UAV B can carry the radar devices. UAV C and UAV D can carry the spectral cameras. The required payload for performing the target task can be the radar device. UAV A, UAV B, UAV C, and UAV D can have remaining battery power C₁, C₂, C₃, and C₄, respectively, and C₄<C₂<C₁<C₃. Since UAV A carries the radar device, the payload required for performing the target task is the radar device, and UAV A has the most remaining battery power, UAV A can be determined as the target UAV.

For example, the UAV corresponding to the payload matching result of the first payload type matching the second payload type can be determined as the candidate UAV. The candidate UAV having the most remaining battery power and being in the idle state can be selected from the at least one candidate UAV and determined as the target UAV. For example, the dock apparatus can include UAV A, UAV B, UAV C, and UAV D. UAV A and UAV B can carry the radar devices, UAV C and UAV D can carry the spectral cameras. UAV A and UAV B can be in the idle state. UAV A, UAV B, UAV C, and UAV D can have remaining battery power C₁, C₂, C₃, and C₄, with C₄<C₂<C₁<C₃. The payload required for the target task can be the radar device. Since UAV A carries the radar device, the payload required for performing the target task is the radar device, UAV A has the most remaining battery power, and UAV is in the idle state, UAV can be determined as the target UAV.

In some embodiments, controlling the target UAV to perform the target task can include determining a flight path between the dock apparatus and the task execution area according to the first position of the target task execution area and the second position of the dock apparatus and controlling the target UAV to fly to the task execution area to perform the target task along the flight path. By planning the flight path between the dock apparatus and the task execution area, the target UAV can fly safely and quickly to the task execution area to perform the target task.

In some embodiments, determining the flight path between the dock apparatus and the task execution area according to the first position of the task execution area and the second position of the dock apparatus can include obtaining the environment information of the area where the dock apparatus is located collected by the detection device in the dock apparatus, determining the position of the first obstacle between the first position and the second position according to the environment information, and determine the flight path between the dock apparatus and the task execution area according to the position of the first obstacle, the first position, and the second position. The detection device can include at least one of the radar device, a binocular vision device, or a 3D time-of-flight (TOF) sensor. By arranging the detection device at the dock apparatus, when the detection device senses the obstacle, the flight path can be planned to avoid the obstacle. Thus, when the target UAV flies according to the flight path, the target UAV can avoid the obstacle to ensure the flight safety.

In some embodiments, a return request from the target UAV can be obtained. The return request can include the current position of the target UAV. The position of the second obstacle between the current position of the target UAV and the second position of the dock apparatus can be determined according to the environment information collected by the detection device. According to the position of the second obstacle, the current position of the target UAV, and the second position of the dock apparatus, a return flight path of the target UAV can be determined. The return flight path can be sent to the target UAV. By arranging the detection device at the dock apparatus, when the UAV returns to the dock apparatus, and an obstacle is detected, the return flight path can be planned to avoid the obstacle. Thus, when the target UAV returns according to the return flight path, the target UAV can avoid the obstacle to ensure the flight safety.

In some embodiments, when the return request of the target UAV is obtained, the current position of the dock apparatus can be also obtained. The dock apparatus can be deployed at a mobile carrier. The position of the dock apparatus can change when the mobile carrier moves. The current position of the dock apparatus can be sent to the target UAV. Thus, the target UAV can fly to the dock apparatus according to the current position of the dock apparatus. When the detection device detects the target UAV, according to the 3D environment information collected by the detection device, the target UAV can be controlled to land. By deploying the dock apparatus at the mobile carrier, the dock apparatus can move as the mobile carrier moves to improve the application scope of the dock apparatus. When the UAV needs to return, the current position of the dock apparatus can be sent to the UAV. Thus, the UAV can accurately return to the dock apparatus.

In some embodiments, according to the 3D environment information collected by the detection device and the moving speed of the mobile carrier, the target UAV can be controlled to fly towards the idle dock of the dock apparatus. When the target UAV arrives over the idle dock, the target UAV can be controlled to remain stationary relative to the mobile carrier according to the moving speed of the mobile carrier. When the target UAV is stationary relative to the mobile carrier, the target UAV can be controlled to land on the idle dock of the dock apparatus. By controlling the UAV to remain stationary relative to the mobile carrier, the UAV can land on the dock apparatus stably, which ensures the landing safety of the UAV.

In some embodiments, according to the environment information collected by the detection device, the position of the target object near the dock apparatus can be determined. According to the position of the target object and the second position, a reconnaissance flight path can be determined. The at least one UAV can be controlled to fly to the position of the target object for reconnaissance along the reconnaissance flight path. A reconnaissance result returned by the UAV performing a reconnaissance task can be obtained and sent to a control center. The target object can include a person, an animal, a plane, and a vehicle. By arranging the detection device at the dock apparatus, the target object near the dock apparatus can be determined. The UAV can be controlled to perform reconnaissance on the target object, which improves the safety near the dock apparatus.

In the UAV dispatching method of embodiments of the present disclosure, the UAV dispatching instruction sent by the server and the status information of the at least one UAV can be obtained. According to the task description information and the status information in the UAV dispatching instruction, the target UAV configured to perform the target task can be determined from the at least one UAV. Then, the target UAV can be controlled to perform the target task. Thus, the user does not need to transfer the UAV to the task execution area or the position near the task execution area and can still use the UAV to perform the task, which greatly improves the application convenience and application range of the UAV. The user experience can be also improved.

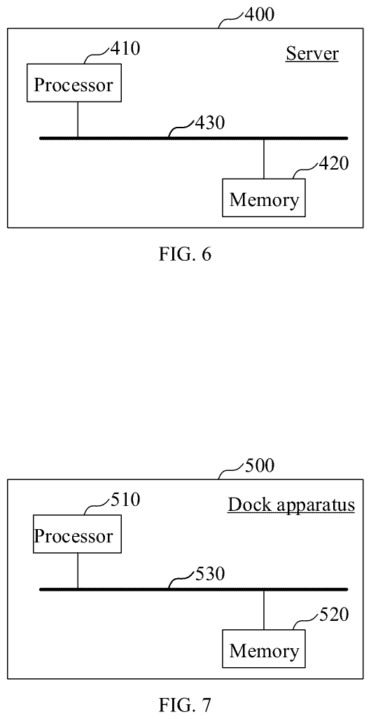

FIG. 6 is a schematic structural block diagram of a server 400 consistent with an embodiment of the present disclosure.

As shown in FIG. 6, the server 400 includes a processor 410 and a memory 420. The processor 410 and the memory 420 can be connected through a bus 430. The bus 430 can be, for example, an Inter-integrated Circuit (I2C) bus. The server 400 can be configured to be communicatively connected to the at least one dock apparatus. Each dock apparatus can be configured to be communicatively connected to at least one UAV.

In some embodiments, the processor 410 can be a microcontroller unit (MCU), a central processing unit (CPU), or a digital signal processor (DSP).

In some embodiments, the memory 420 can be a flash memory chip, a read-only memory (ROM) disk, an optical disk, a USB flash drive, or an external hard drive.

The processor 410 can be configured to run a computer program stored in the memory 420 to obtain the task description information of the to-be-performed target task and the status information of the at least one dock apparatus, according to the task description information and the status information, determine the target dock apparatus from the at least one dock apparatus, and send the UAV dispatching instruction to the target dock apparatus to instruct the target dock apparatus to select the target UAV from the at least one UAV to perform the target task according to the task description information in the UAV dispatching instruction.

In some embodiments, the task description information can include the first position of the task execution area of the target task. The status information can include the second position of the dock apparatus. When determining the target dock apparatus from the at least one dock apparatus according to the task description information and the status information, the processor can be configured to according to the first position and the second position of each dock apparatus, determine the first distance between the task execution area and each dock apparatus and determine the target dock apparatus from the at least one dock apparatus according to each first distance.

In some embodiments, when determining the target dock apparatus from the at least one dock apparatus according to each first distance, the processor can be configured to determine the dock apparatus corresponding to the shortest first distance as the target dock apparatus.

In some embodiments, when determining the target dock apparatus from the at least one dock apparatus according to the task description information and the status information, the processor can be configured to determine the first length corresponding to the flight path between the task execution area and each dock apparatus according to the first position and the second position of each dock apparatus and determine the target dock apparatus from the at least one dock apparatus according to the first length corresponding to each flight path.

In some embodiments, when determining the target dock apparatus from the at least one dock apparatus according to the first length corresponding to each flight path, the processor can be configured to determine the dock apparatus corresponding to the shortest first length as the target dock apparatus.

In some embodiments, the task description information can include the first payload type of the payload required for the target task. The status information can include the second payload type of the payload of the at least one UAV communicatively connected to the dock apparatus. When determining the target dock apparatus from the at least one dock apparatus according to the task description information and the status information, the processor can be configured to match the first payload type with the second payload type to obtain a payload matching result and determine the target dock apparatus from the at least one dock apparatus according to the payload matching result.

In some embodiments, when determining the target dock apparatus from the at least one dock apparatus according to the payload matching result, the processor can be configured to determine the dock apparatus corresponding to the payload matching result of the second payload type matching the first payload type as the target dock apparatus.

In some embodiments, the task description information can further include the first position of the task execution area of the target task, and the status information can further include the second position of the dock apparatus. The processor can be configured to determine the dock apparatuses corresponding to the payload matching result of the second payload type matching the first payload type as the candidate dock apparatuses and determine the target dock apparatus from the candidate dock apparatuses.

In some embodiments, when determining the target dock apparatus from the candidate dock apparatuses, the processor can be configured to determine the second distance between the task execution area and each candidate dock apparatus according to the first position of the task execution area for the target task and the second position of each candidate dock apparatus and determine the target dock apparatus from the at least one candidate dock apparatus according to each second distance.

In some embodiments, when determining the target dock apparatus from the at least one candidate dock apparatus according to each second distance, the processor can be configured to determine the candidate dock apparatus corresponding to the shortest second distance as the target dock apparatus.

In some embodiments, when determining the target dock apparatus from the candidate dock apparatuses, the processor can be configured to determine a second length corresponding to the flight path between the task execution area and each candidate dock apparatus according to the first position of the task execution area for the target task and the second position of each candidate dock apparatus and determine the target dock apparatus from the at least one candidate dock apparatus according to each second length.

In some embodiments, when determining the target dock apparatus from the at least one candidate dock apparatus according to each second length, the processor can be configured to determine the candidate dock apparatus corresponding to the shortest second length as the target dock apparatus.

In some embodiments, the status information can also include the meteorological weather information in the area where the dock apparatus is located. When determining the target dock apparatus from the candidate dock apparatuses, the processor can be configured to filter the candidate dock apparatuses according to the meteorological information, the meteorological information of the filtered candidate dock apparatuses satisfying the predetermined meteorological condition, and determine the target dock apparatus from the filtered candidate dock apparatuses.

In some embodiments, the processor can be further configured to obtain a prepare-to-land request sent by a prepare-to-land UAV, determine a prepare-to-land dock apparatus configured to prepare the landing of the prepare-to-land UAV from the at least one dock apparatus according to the prepare-to-land request, and control the prepare-to-land UAV to fly to the prepare-to-land dock apparatus.

In some embodiment, the prepare-to-land request can include the current position of the prepare-to-land UAV. When determining the prepare-to-land dock apparatus configured to prepare the landing of the prepare-to-land UAV from the at least one dock apparatus according to the prepare-to-land request, the processor can be configured to obtain the second position of the at least one dock apparatus, and determine the prepare-to-land dock apparatus from the at least one dock apparatus according to the second position and the current position of the prepare-to-land UAV.

In some embodiments, when determining the prepare-to-land dock apparatus from the at least one dock apparatus according to the second position and the current position of the prepare-to-land UAV, the processor can be configured to determine the third distance between the prepare-to-land UAV and each dock apparatus according to the current position of the prepare-to-land UAV and the second position, and determine the prepare-to-land dock apparatus from the at least one dock apparatus according to the third distance.

In some embodiments, when determining the prepare-to-land dock apparatus from the at least one dock apparatus according to the third distance, the processor can be configured to determine the dock apparatus corresponding to the shortest third distance as the prepare-to-land dock apparatus.

In some embodiments, the processor can be further configured to obtain the third position of the task-ending waypoint of the target UAV, the task-ending waypoint being a waypoint when the target UAV completing the target task, determine the fourth distance between the target dock apparatus and the task ending waypoint of the target UAV according to the third position and the position of the target dock apparatus, and when the fourth distance is smaller than or equal to the predetermined distance, control the target UAV to fly to the target dock apparatus after completing the target task.

In some embodiments, the processor can be further configured to when the fourth distance is greater than the predetermined distance, determine the return dock apparatus for the returning of the target UAV from the at least one dock apparatus and control the target UAV to fly to the return dock apparatus after completing the target task.

In some embodiments, when determining the return dock apparatus for the returning of the target UAV from the at least one dock apparatus, the processor can be configured to determine the dock apparatus from the at least one dock apparatus closest to the target UAV as the return dock apparatus.

In some embodiments, the processor can be further configured to obtain the UAV maintenance request, the UAV maintenance request including the current position of the to-be-maintained UAV and the fourth position of the maintenance point, obtain the battery information of the to-be-maintained UAV and determine the remaining flight distance of the to-be-maintained UAV according to the battery information, determine the target flight path for the to-be-maintained UAV to fly to the maintenance point according to the current position of the to-be-maintained UAV, the fourth position, and the remaining flight distance, and control the to-be-maintained UAV to fly to the maintenance point along the target flight path.

In some embodiments, when determining the target flight path for the to-be-maintained UAV to fly to the maintenance point according to the current location of the to-be-maintained UAV, the fourth position, and the remaining flight distance, the processor can be configured to determine the first flight path between the to-be-maintained UAV and the maintenance point according to the current position of the to-be-maintained UAV and the fourth position and determine the first flight path as the target flight path when the length corresponding to the first flight path is less than or equal to the remaining flight distance.

In some embodiments, the processor can be further configured to, when the length corresponding to the first flight path is greater than the remaining flight distance, determine a power supply dock apparatus from the at least one dock apparatus according to the current position, the fourth position, and the remaining flight distance, determine the second flight path formed by the current position, the position of the at least one power supply dock apparatus, and the fourth position, the flight distance between two neighboring waypoints in the second flight path being smaller than or equal to the remaining flight distance, and determine the second flight path as the target flight path to cause the to-be-maintained UAV to be able to fly to the maintenance point from the current position through at least one power supply dock apparatus.

Those skilled in the art can understand that for the specific operational processes of the server, reference can be made to corresponding processes in embodiments of the UAV dispatching method above, which is not repeated here.

FIG. 7 is a schematic structural block diagram of a dock apparatus 500 consistent with an embodiment of the present disclosure.

As shown in FIG. 7, the dock apparatus 500 includes a processor 510 and memory 520. The processor 510 and memory 520 are connected via a bus 530. The bus 530 can be an I2C bus. The dock apparatus 500 can be configured to be communicatively connected to a server and at least one UAV.

In some embodiments, the processor 510 can be a microcontroller unit (MCU), a central processing unit (CPU), or a digital signal processor (DSP).

In some embodiments, the memory 520 can be a flash chip, a read-only memory (ROM), a disk, an optical disk, a USB drive, or an external hard drive.

The processor 510 can be configured to run the computer program stored in the memory 520 to obtain the status information of the at least one UAV, obtain the UAV dispatching instruction sent by the server, the UAV dispatching instruction including the task description information of the to-be-performed target task, according to the task description information and the status information, determine the target UAV from the at least one UAV for performing the target task, and control the target UAV to perform the target task.

In some embodiments, the task description information can include the first payload type required for the target task. The status information can include the second payload type of the payload of the at least one UAV. When determining the target UAV from the at least one UAV for performing the target task according to the task description information and the status information, the processor can be configured to match the first payload type with the second payload type to obtain the payload matching result and determine the target UAV from the at least one UAV according to the payload matching result.

In some embodiments, when determining the target UAV from the at least one UAV according to the payload matching result, the processor can be configured to determine the UAV corresponding to the payload matching result of the first payload type matching the second payload type as the target UAV.

In some embodiments, when determining the target UAV from the at least one UAV according to the payload matching result, the processor can be configured to determine the UAVs corresponding to the payload matching result of the first payload type matching the second payload type as the candidate UAVs and determine the candidate UAV corresponding to the most remaining battery power from the at least one candidate UAV as the target UAV.

In some embodiments, the task description information can include the first position of the task execution area of the target task. When controlling the target UAV to perform the target task, the processor can be configured to determine the flight path between the dock apparatus and the task execution area according to the first position and the second position of the dock apparatus and controlling the target UAV to fly to the target execution area to perform the target task along the flight path.

In some embodiments, the dock apparatus can include the detection device. The processor can be further configured to obtain the environment information of the area where the dock apparatus is located collected by the detection device, determine the position of the first obstacle between the first position and the second position according to the environment information, and determine the flight path between the dock apparatus and the task execution area according to the position of the first obstacle, the first position, and the second position.

In some embodiments, the processor can be further configured to obtain the return request sent by the target UAV, the return request including the current position of the target UAV, determine the position of the second obstacle between the current position of the target UAV and the second position according to the environment information collected by the detection device, determine the return flight path of the target UAV according to the position of the second obstacle, the current position of the target UAV, and the second position, and send the return flight path to the target UAV.

In some embodiments, the processor can be further configured to determine the position of the target object near the dock apparatus according to the environment information collected by the detection device, determine the reconnaissance flight path according to the position of the target object and the second position, control the at least one UAV to fly to the position of the target object for reconnaissance along the reconnaissance flight path, and obtain the reconnaissance result returned by the UAV for performing the reconnaissance task.

Those skilled in the art can understand that for the specific operational processes of the dock apparatus, reference can be made to the corresponding processes in embodiments of the UAV dispatching method above, which is not repeated here.

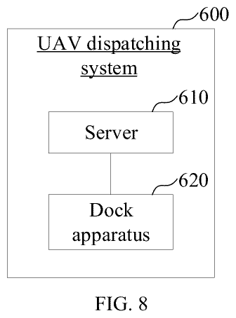

FIG. 8 is a schematic structural block diagram of a UAV dispatching system 600 consistent with an embodiment of the present disclosure.

As shown in FIG. 8, the UAV dispatching system 600 includes a server 610 and at least one UAV dock apparatus 620. The server 610 is communicatively connected to the at least one dock apparatus 620. Each dock apparatus 620 can be configured to be communicatively connected to the at least one UAV. The server 610 can be the server 400 shown in FIG. 6, and the dock apparatus 620 can be the dock apparatus 500 shown in FIG. 7.

Those skilled in the art will understand that for the specific operational processes of the UAV dispatching system, reference can be made to the corresponding processes in embodiments of the UAV dispatching method above, which is not repeated here.

The present disclosure also provides a computer-readable storage medium that stores a computer program including program instructions. The processor can be configured to execute the program instructions to implement the processes of the UAV dispatching method above.

The computer-readable storage medium can be an internal storage unit of the server or the dock apparatus of any embodiment above, such as the hard drive or memory of the server or dock apparatus. The computer-readable storage medium can also be an external storage apparatus of the server or the dock apparatus, such as a plug-in hard drive, a Smart Media Card (SMC), a Secure Digital (SD) card, a flash card, equipped on the server or the dock apparatus.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The terminology used in the present disclosure is for the purpose of describing specific embodiments and is not intended to limit the present disclosure. As used in the present disclosure and the appended claims, unless the context clearly indicates otherwise, the singular forms “a,” “an,” and “the” also include plural forms.

The term “and/or” used in the present disclosure and the appended claims refers to any one or more of the items listed in connection with one another or in any combination and all combinations thereof.

The above are some embodiments of the present disclosure. However, the present disclosure is not limited to this. Those skilled in the art can easily think of various equivalent modifications or replacements within the technical scope of the present disclosure. These modifications and replacements are within the scope of the present disclosure. Thus, the scope of the present disclosure is subject to the scope of the claims.

What is claimed is:

1. A server comprising:
at least one processor; and
at least one memory including computer program code, where the at least one memory and the computer program code are configured, with the at least one processor, to cause the server to at least:
obtain task description information of a target task and status information of one or more dock apparatuses communicatively connected to the server;
determine a target dock apparatus from the one or more dock apparatuses according to the task description information and the status information; and
send a dispatching instruction to the target dock apparatus to instruct the target dock apparatus to select, according to the dispatching instruction, a target UAV from one or more UAVs to perform the target task, the one or more UAVs being carried by and communicatively connected to the target dock apparatus.

2. The server according to claim 1, wherein the at least one memory and the computer program code are further configured, with the at least one processor, to cause the server further to:
determine one or more candidate dock apparatuses from the one or more dock apparatuses and determine the target dock apparatus from the one or more candidate dock apparatuses; and/or
determine one or more candidate UAVs from the one or more UAVs and determine the target UAV from the one or more candidate UAVs.

3. The server according to claim 1, wherein:
the task description information includes a first position of a task execution area of the target task, and the status information includes a second position of each dock apparatus of the one or more dock apparatuses; and
the at least one memory and the computer program code are further configured, with the at least one processor, to cause the server further to:
determine the target dock apparatus from the one or more dock apparatuses according to the first position and the second position of each dock apparatus; or
determine one or more candidate dock apparatuses from the one or more dock apparatuses according to the first position and the second position of each dock apparatus and determine the target dock apparatus from the one or more candidate dock apparatuses.

4. The server according to claim 3, wherein the at least one memory and the computer program code are further configured, with the at least one processor, to cause the server further to:
for each dock apparatus, determine, according to the first position and the second position of the dock apparatus, a distance between and/or a length corresponding to a flight path between the task execution area and the dock apparatus; and
determine the target dock apparatus according to the distance and/or the length corresponding to the flight path of each dock apparatus.

5. The server according to claim 1, wherein:
the task description information includes a first payload type of a payload for the target task, and the status information includes a second payload type of a payload of a UAV of the one or more UAVs; and
the at least one memory and the computer program code are further configured, with the at least one processor, to cause the server further to:
match the first payload type with the second payload type to obtain a payload matching result; and
determine the target dock apparatus from the one or more dock apparatuses according to the payload matching result.

6. The method according to claim 5, wherein the at least one memory and the computer program code are further configured, with the at least one processor, to cause the server further to:
determine a dock apparatus corresponding to the payload matching result indicating that the second payload type matches the first payload type as the target dock apparatus; or
determine one or more candidate dock apparatuses each corresponding to the payload matching result indicating that the second payload type matches the first payload type and determine the target dock apparatus from the one or more candidate dock apparatuses.

7. The server according to claim 6, wherein:
the task description information further includes a first position of a task execution area of the target task, the status information further includes a second position of each dock apparatus of the one or more dock apparatuses, and the at least one memory and the computer program code are further configured, with the at least one processor, to cause the server further to:
determine the target dock apparatus from the one or more candidate dock apparatuses according to the first position and the second position; or
the status information further includes meteorological information of an area where the dock apparatus is located, and the at least one memory and the computer program code are further configured, with the at least one processor, to cause the server further to:
filter the one or more candidate dock apparatuses according to the meteorological information to determine at least one filtered candidate dock apparatus, the meteorological information of the at least one filtered candidate dock apparatus satisfying a predetermined meteorological condition; and
determine the target dock apparatus from the at least one filtered candidate dock apparatus.

8. The server according to claim 1, wherein the at least one memory and the computer program code are further configured, with the at least one processor, to cause the server further to:
obtain a prepare-to-land request sent by a prepare-to-land UAV;
determine a prepare-to-land dock apparatus configured to prepare landing of the prepare-to-land UAV from the one or more dock apparatuses according to the prepare-to-land request; and
control the prepare-to-land UAV to fly to the prepare-to-land dock apparatus.

9. The server according to claim 8, wherein:
the prepare-to-land request includes a current position of the prepare-to-land UAV;
the at least one memory and the computer program code are further configured, with the at least one processor, to cause the server further to:
obtain a position of each of the one or more dock apparatuses; and
determine the prepare-to-land dock apparatus from the one or more dock apparatuses according to the position of each of the one or more dock apparatuses and the current position of the prepare-to-land UAV.

10. The server according to claim 9, wherein the at least one memory and the computer program code are further configured, with the at least one processor, to cause the server further to:
determine a distance between the prepare-to-land UAV and each dock apparatus according to the current position of the prepare-to-land UAV and the position of the each dock apparatus and/or a length corresponding to a flight path for the prepare-to-land UAV to fly to each dock apparatus of the one or more dock apparatuses according to the current position of the prepare-to-land UAV and the position of the each dock apparatus; and
determine the prepare-to-land dock apparatus from the one or more dock apparatuses according to the distance and/or the length corresponding to the flight path.

11. The server according to claim 1, wherein the at least one memory and the computer program code are further configured, with the at least one processor, to cause the server further to:
control the target UAV to fly to a dock apparatus other than the target dock apparatus after completing the target task.

12. The server according to claim 11, wherein the at least one memory and the computer program code are further configured, with the at least one processor, to cause the server further to:
obtain a task-ending waypoint of the target UAV, the task-ending waypoint being a waypoint where the target UAV completes the target task; and
control the target UAV to fly to the dock apparatus other than the target dock apparatus after completing the target task in response to at least one of:
a distance from the task-ending waypoint to the dock apparatus other than the target dock apparatus being smaller than a first predetermined distance;
a distance from the task-ending waypoint to the target dock apparatus being greater than a second predetermined distance; or
the distance from the task-ending waypoint to the dock apparatus other than the target dock apparatus being smaller than the distance from the task-ending waypoint to the target dock apparatus.

13. The server according to claim 1, wherein the at least one memory and the computer program code are further configured, with the at least one processor, to cause the server further to:
obtain a position of a task-ending waypoint of the target UAV, the task-ending waypoint being a waypoint where the target UAV completes the target task;
determine a distance between the target dock apparatus and the task-ending waypoint of the target UAV according to the position of the task-ending waypoint and the position of the target dock apparatus; and
control the target UAV based at least on the distance, including:
controlling the target UAV to fly to the target dock apparatus after completing the target task in response to the distance being smaller than or equal to a predetermined distance; or
in response to the distance being greater than the predetermined distance, determining, from the one or more dock apparatuses, a return dock apparatus for the target UAV to return to, and control the target UAV to fly to the return dock apparatus after completing the target task, the return dock apparatus and the target dock apparatus being different dock apparatuses.

14. The server according to claim 1, wherein the at least one memory and the computer program code are further configured, with the at least one processor, to cause the server further to:
obtain a UAV maintenance request including a current position of a to-be-maintained UAV and a position of a maintenance point;
obtain power information of the to-be-maintained UAV;
determine a target flight path for the to-be-maintained UAV to fly to the maintenance point according to the current position of the to-be-maintained UAV, the position of the maintenance point, and the power information of the to-be-maintained UAV; and
control the to-be-maintained UAV to fly along the target flight path to the maintenance point.

15. The server according to claim 14, wherein the at least one memory and the computer program code are further configured, with the at least one processor, to cause the server further to:
determine a remaining flight distance of the to-be-maintained UAV according to the power information;
determine a first flight path between the to-be-maintained UAV and the maintenance point according to the current position of the to-be-maintained UAV and the position of the maintenance point; and
determine the target flight path based at least on the first flight path, including:
determining the first flight path as the target flight path in response to a length corresponding to the first flight path being smaller than or equal to the remaining flight distance; or
in response to the length corresponding to the first flight path being greater than the remaining flight distance:
determining a power supply dock apparatus from the one or more dock apparatuses;
determining a second flight path including the current position of the to-be-maintained UAV, a position of the power supply dock apparatus, and the position of the maintenance point as waypoints, a flight distance between two neighboring waypoints of the second flight path being smaller than or equal to the remaining flight distance; and
determining the second flight path as the target flight path to cause the to-be-maintained UAV to fly to the maintenance point from the current position through the power supply dock apparatus.

16. A server comprising:
at least one processor; and
at least one memory including computer program code, where the at least one memory and the computer program code are configured, with the at least one processor, to cause the server to at least:
obtain task description information of a target task;
obtain status information of one or more UAVs carried by a target dock apparatus and communicatively connected to the target dock apparatus; and
send a dispatching instruction to the target dock apparatus to instruct the target dock apparatus to select, from the one or more UAVs, a target UAV to perform the target task, and control the target UAV to perform the target task, the dispatching instruction being generated based on the task description information and the status information.

17. The server according to claim 16, wherein:
the task description information includes a first payload type of a payload for the target task, and the status information includes a second payload type of a payload of a UAV of the one or more UAVs; and
the at least one memory and the computer program code are further configured, with the at least one processor, to cause the server further to:
match the first payload type with the second payload type to obtain a payload matching result; and
determine the target UAV from the one or more UAVs according to the payload matching result.

18. The server according to claim 17, wherein the at least one memory and the computer program code are further configured, with the at least one processor, to cause the server further to:
determine a dock apparatus corresponding to the payload matching result indicating that the second payload type matches the first payload type as the target dock apparatus; or
determine one or more candidate UAVs each corresponding to the payload matching result indicating that the second payload type matches the first payload type and determine a candidate UAV with remaining power satisfying a predetermined condition from the one or more candidate UAVs as the target UAV.

19. The server according to claim 16, wherein the at least one memory and the computer program code are further configured, with the at least one processor, to cause the server further to:
obtain information of a target object around the target dock apparatus; and
determine a flight path of the target UAV according to the information of the target object;
wherein:
when the target object includes an obstacle, the target UAV avoids the obstacle during a process of performing the target task along the flight path; and/or
when the target object includes a task object, the target UAV performs the target task at a position indicated by the task object along the flight path.

20. The server according to claim 19, wherein:
the information of the target object around the target dock apparatus is obtained based on a detection device of the target dock apparatus; and the target dock apparatus is in a moving status or a static status.
